(19) United States
(12) Patent Application Publication
(10) Pub. No.: US 2005/0149855 A1
(43) Pub. Date: Jul. 7, 2005

(54) Graphical scratchpad

(76) Inventors: Rose Pon Loo, Pleasanton, CA (US); Lewis W.B. Charnock, Harleysville, PA (US); Janaki P. Kumar, Palo Alto, CA (US); Vivek Bhanuprakash, Sunnyvale, CA (US); Deborah Rodgers, Framingham, MA (US)

Correspondence Address: FISH & RICHARDSON, P.C., PO BOX 1022, MINNEAPOLIS, MN, 55440-1022, US

(21) Appl. No.: 10/886,929

(22) Filed: Jul. 8, 2004

Related U.S. Application Data
(60) Provisional application No. 60/512,966, filed on Oct. 21, 2003.

(51) Int. Cl. G06F 17/21

(52) U.S. Cl. 715/508; 715/505; 715/506; 715/507

(57) ABSTRACT

One embodiment provides a method for providing a scratchpad window in a graphical user interface (GUI) while using an application that manages an interaction between an agent and an individual. Upon entry of a first selection made by the agent in an application window used by the application and displayed in the GUI to the agent during the interaction with the individual, the method includes displaying the scratchpad window in the GUI and accepting input from the agent that is entered as information into the scratchpad window. Upon entry of a second selection made by the agent in the application window within the GUI, the method further includes importing the information contained within the scratchpad window into a data-entry area of the application window.

### RELATED APPLICATION

The present application claims the benefit of the filing date of U.S. Provisional Application No. 60/512,966, which was filed on Oct. 21, 2003.

### TECHNICAL FIELD

This invention relates to the use of a graphical scratchpad in a user interface of a computing system.

### BACKGROUND

In recent years, telephone call centers have become much more widespread. The call centers manage many efforts, and call-center agents working in these centers often place and receive thousands of calls to and from various customers in different regions of the country. These agents often use headsets to speak with customers while they concurrently enter information relating to the customers into a computer workstation. The workstation may provide electronic forms for the entry of customer information.

More recently, telephone call centers have evolved into full-scale interaction centers, wherein agents may interact with customers via telephone, email, fax, or chat communication channels. Through the use of these interaction centers, agents are able to interact with customers in many different ways.

Additionally, agents have the ability to interact with two or more customers at the same time. For instance, an agent may be able to speak with one customer on the phone and concurrently interact with another customer in a chat session. As a result, the agent may be able to improve his or her efficiency.

A high volume of customer interaction may, however, have the potential of introducing certain problems for agents. For instance, an agent may receive a continuous stream of information from a given customer during the course of a telephone or chat communication session. Typically, the agent will need either to remember or to manually record all of this information if it is needed later during a subsequent portion of the communication session.

### SUMMARY

Various embodiments are described herein. One embodiment provides a method for providing a scratchpad window in a graphical user interface (GUI) while using an application that manages an interaction between an agent and an individual. Upon entry of a first selection made by the agent in an application window used by the application and displayed in the GUI to the agent during the interaction with the individual, the method includes displaying the scratchpad window in the GUI and accepting input from the agent that is entered as information into the scratchpad window. Upon entry of a second selection made by the agent in the application window within the GUI, the method further includes importing the information contained within the scratchpad window into a data-entry area of the application window.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a block diagram of a system that may be used during interactions between a customer and a customer service agent, according to one embodiment.

FIG. 2A through FIG. 2D are screen diagrams of application and scratchpad windows that may be displayed on the agent computing devices shown in FIG. 1.

FIG. 3A and FIG. 3B are screen diagrams of application and scratchpad windows in an interaction center application, according to one embodiment.

FIG. 4 is a block diagram of a computing system that may be included within the customer and/or agent computing devices shown in FIG. 1, according to one embodiment.

### DETAILED DESCRIPTION

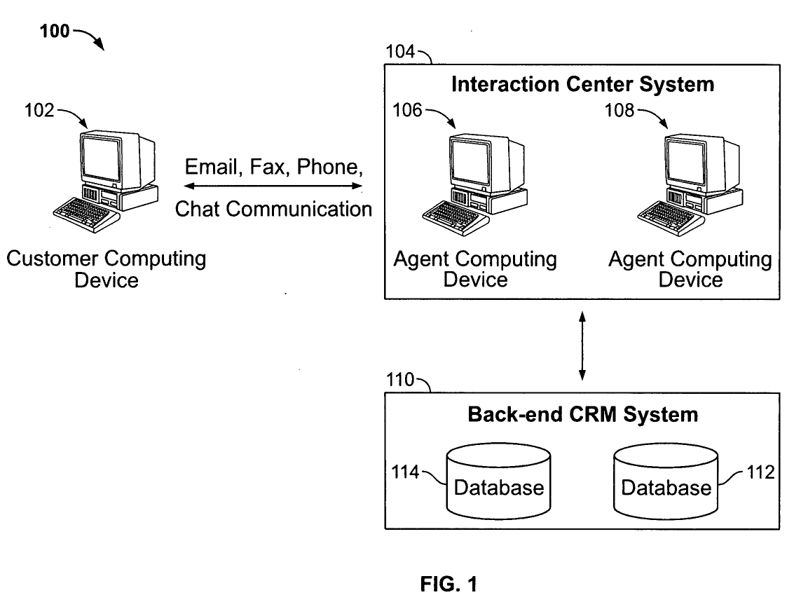

FIG. 1 is a block diagram of a system 100 that may be used during interactions between a customer and a customer service agent, according to one embodiment. In this embodiment, the customer uses a computing device 102 to interact with the agent. The agent uses a computing device 106 or 108 within an interaction center system 104.

During the interaction with the customer, the agent may wish to record notes that are based upon feedback received from the customer or that may have relevance to the interaction in general. Rather than manually recording these notes, the agent may instead record these notes in a graphical scratchpad using the computing device 106 or 108. In addition, the agent is able to later access the graphical scratchpad and import the notes into text-entry fields that are used during the interaction with the customer. For example, during a first phase of a customer interaction, the agent may record in the graphical scratchpad many details of a problem that the customer has identified. Later, during a second phase of the customer interaction, the agent may then import these details from the graphical scratchpad into a text-entry field that specifies problem details. In this fashion, the agent is able to dynamically record notes and import these notes during multiple phases of interaction with the customer.

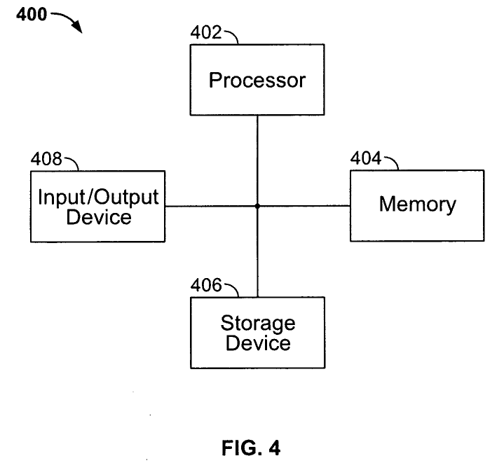

As shown in FIG. 1, the customer may interact with the agent in the interaction center using various different modes of communication. For example, the customer may use the computing device 102 to communicate with the agent in the interaction center system 104 by email, fax, or phone. Alternatively, the customer may engage in an interactive chat session with the agent. When using the computing device 106 or 108, the agent is able to respond to the customer using these and other modes of communication. In one embodiment, the computing devices 102, 106, and 108 contain the computing system 400 shown in FIG. 4. In one embodiment, the customer initiates the interaction with the agent by generating a request that is sent from the computing device 102 to the interaction center system 104. In one embodiment, the interaction center system 104 contains a server management system (not shown) that interacts with each agent computing device 106 and 108. In this embodiment, the server management system helps manage and oversee the interaction between the customer computing device 102 and the agent computing devices 106 and 108. The agent computing devices 106 and 108 may continually interact with the server management system during the course of any given interaction.

During any given interaction with the customer, the interaction center system 104 often needs to exchange information with a back-end customer relationship management (CRM) system 110. The back-end system 110 contains databases 112 and 114. The interaction center system 104 may access the databases 112 and 114 during any given interaction with a customer. In one embodiment, the databases 112 and 114 contain customer information, historical information, and transaction (e.g., sales order or service order) information. In one embodiment, the databases 112 and 114 also contain contents of the graphical scratchpad that have been created by the agent on the computing device 106 or 108. When the agent enters or modifies information contained in the graphical scratchpad, this information is stored in the database 112 or 114. The information is then extracted from the database 112 or 114 and sent to the computing device 106 or 108 when the agent wishes to import the information contained within the graphical scratchpad. In an alternate embodiment, the contents of the graphical scratchpad are contained within memory of the computing device 106 or 108. In this embodiment, an application running on the computing device 106 or 108 accesses its memory when storing information in or extracting information from the graphical scratchpad.

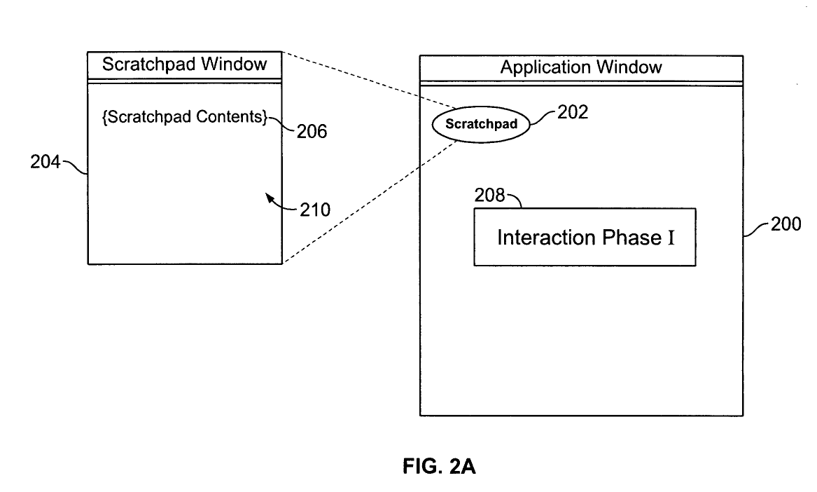

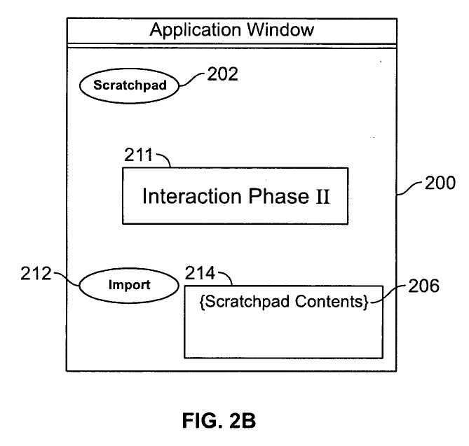

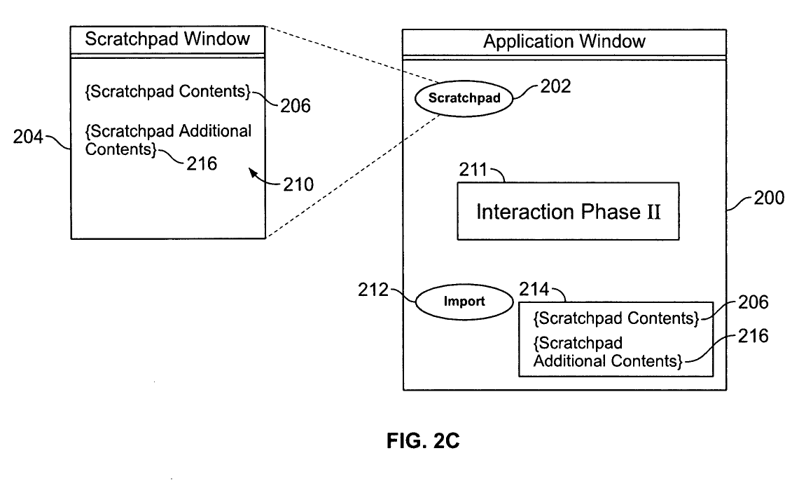

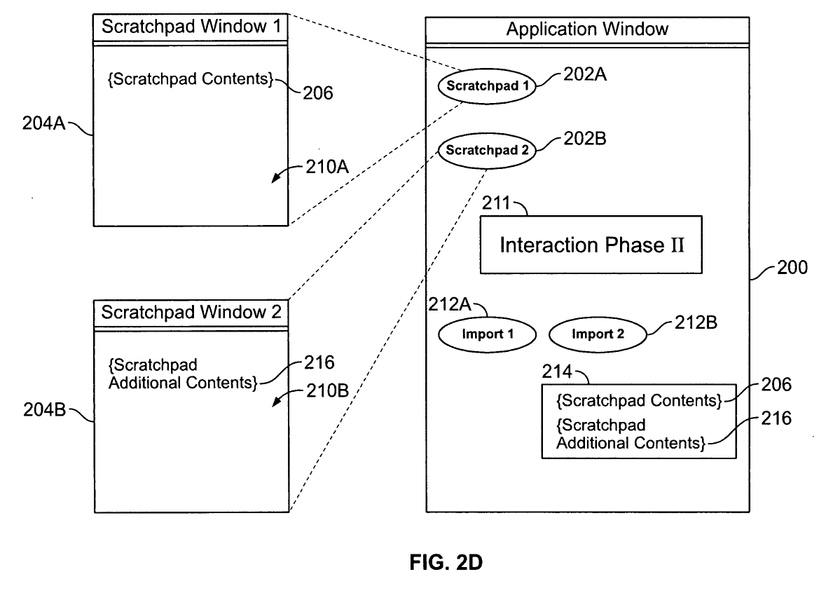

FIG. 2A through FIG. 2D are screen diagrams of application and scratchpad windows that may be displayed on the agent computing devices 106 or 108 shown in FIG. 1, according to one embodiment. These various windows are displayed to an agent during an interaction with a given customer. FIG. 2A is a screen diagram of an application window 200 and a graphical scratchpad window 204. While the agent uses the computing device 106 or 108 when interacting with a customer, the application window 200 is displayed to the agent in a graphical user interface (GUI). For example, the application window 200 may be associated with an interaction center application, such as a sales or a service order application. The application window 200 is displayed to the agent during the interaction with the customer. The agent may read information that is displayed in the window 200, and may also enter information into the window 200. For example, if the window 200 contains various menus or text-entry fields, the user is able to make menu selections or type text into the text-entry fields.

Typically, a given interaction with a customer will include a series of different phases. For example, in a sales order application, the agent may obtain product information from the customer in a first phase, and may later obtain shipping information in a second phase. During each phase, a set of corresponding window elements (e.g., menus, fields, buttons, text) that are specific to that phase of the interaction are displayed within the application window 200. In FIG. 2A, a screen area 208 within the application window 200 includes a set of window elements that are specific to a first phase of an interaction with a customer. The application window 200 also includes a scratchpad button 202. The scratchpad button 202 is persistently displayed within the application window 200 during various phases of the interaction with the customer, according to one embodiment.

When the agent selects the button 202, the scratchpad window 204 is displayed within the GUI to the agent. In one embodiment, the scratchpad window 204 is a pop-up window. The scratchpad window 204 contains scratchpad contents 206. If the agent has selected the scratchpad button 202 for the first time during the interaction, the scratchpad contents 206 will be empty. If the agent has previously entered information into the scratchpad window 204, the scratchpad contents 206 will include this information and display it to the agent within the GUI. In one embodiment, the scratchpad window 204 includes a scroll-bar. By using the scroll-bar, the agent can see all of the previously entered information for the scratchpad contents 206.

The scratchpad window 204 also includes a data-entry area 210. By using the data-entry area 210, the agent is able to enter additional information into the scratchpad window 204. For example, the agent may type a note into the data-entry area 210 upon receiving information from the customer during a first phase of the interaction. The agent also has the ability to modify the existing scratchpad contents 206 once the scratchpad window 204 has been opened. In one embodiment, the agent enters a selection to close the scratchpad window 204 when the agent has finished using it. In another embodiment, the scratchpad window 204 automatically closes after determining that the agent has finished using the window. For example, if the agent has not entered text or made a selection within the scratchpad window 204 for a period of thirty seconds, the GUI may automatically close the scratchpad window 204.

If the agent selects and activates the application window 200, the scratchpad window 204 is sent to the background and designated as a background window, according to one implementation. In this case, the scratchpad window 204 is deactivated when the application window 200 is activated.

FIG. 2B is a screen diagram of the application window 200 that is displayed to the agent during a second phase of the interaction with the customer. During this phase, the agent is able to import the contents of the scratchpad window 204 into a data-entry area. As shown in FIG. 2B, the application window 200 contains a window area 211 that contains a set of window elements that are specific to the second phase of the interaction. For example, the window area 211 may contain menus, buttons, fields, etc. that are specific to the second phase of the interaction. The application window 200 also contains an import button 212 and a data-entry area 214. In one embodiment, the data-entry area 214 is a text-entry area that is associated with the window area 211, such that the data-entry area 214 is specific to the second phase of the interaction with the customer. By selecting the import button 212, the agent is able to automatically import the contents of the scratchpad window 204 into the data-entry area 214. As shown in FIG. 2B, the scratchpad contents 206 are included within the data-entry area 214 after the agent has selected the import button 212. In one embodiment, the agent may use the import button 212 or an alternate mechanism to import only a portion of the contents of the scratchpad window 204 into the data-entry area 214. For example, the agent could configure the use of the import button 212 such that, when the agent selects the import button 212 a first time, a first full paragraph of text is imported from the scratchpad window 204 into the data-entry area 214. When the agent selects the import button 212 a second time, a second full paragraph of text is imported from the scratchpad window 204 into the data-entry area 214.

In one embodiment, the agent is capable of modifying the scratchpad contents 206 within the data-entry area 214 after they have been imported. In this fashion, the agent can customize the scratchpad contents within the data-entry area 214 during the second phase of the interaction.

FIG. 2C is a screen diagram of the application window 200 shown in FIG. 2B and the scratchpad window 204 shown in FIG. 2A, in which the agent has entered additional content into the scratchpad window 204. As described previously, the agent may select the scratchpad button 202 within the application window 200 to see a display of the scratchpad window 204. Assuming that the agent has previously entered information into the graphical scratchpad, the GUI displays to the agent the current scratchpad contents 206. The scratchpad window 204 also contains a data-entry area 210, such that the agent may enter additional information into the graphical scratchpad. Assuming that the agent enter such additional information, the GUI displays to the agent the additional contents 216.

If the agent wishes to import the contents of the graphical scratchpad, the agent selects the import button 212. As shown, the scratchpad contents 206 and the additional contents 216 that were added by the agent are each imported into the data-entry area 214. By using the import button 212, the agent is able to quickly and easily import the contents of the graphical scratchpad into an area of the application window 200 that is used during a particular phase of the interaction with the customer.

In one implementation, the scratchpad contents 206 and the additional contents 216 are deleted from the scratchpad window 204 when the interaction between the agent and the customer ends. When the agent later initiates a new interaction with the same or different customer, the agent can use the scratchpad window 204 to store information relating to the new interaction.

FIG. 2D shows an alternate embodiment of a screen diagram containing the application window 200 along with two distinct scratchpad windows 204A and 204B. Using these windows, the agent is able to digitally record notes in multiple scratchpads and then imports these notes into the application window 200. To open the scratchpad window 204A within the GUI, the agent selects the scratchpad button 202A within the application window 200. In one embodiment, the scratchpad window 204A is a pop-up window. The scratchpad contents 206 are displayed within a data-entry area 210A. The scratchpad contents 206 include any previously entered information as well as newly added information by the agent into the data-entry area 210A.

To open the scratchpad window 204B within the GUI, the agent selects the scratchpad button 202B within the application window 200. In one embodiment, the scratchpad window 204B is a pop-up window. The additional contents 216 are displayed within a data-entry area 21 OB. The additional contents 216 include any previously entered information as well as newly added information by the agent into the data-entry area 210B.

During a second phase of an interaction with a customer, the agent may use the import buttons 212A and 212B to import the content of the scratchpad windows 204A and 204B into the data-entry area 214 of the application window 200. In one embodiment, the data-entry area 214 is associated with the window area 211 that includes screen elements (e.g., menus, buttons, fields, text) that are specific to the second phase of the interaction with the customer. By selecting the import button 212A, the agent is able to import the scratchpad contents 206 from the scratchpad window 204A into the data-entry area 214. By selecting the import button 212B, the agent is able to import the additional contents 216 from the scratchpad window 204B into the data-entry area 214.

The use of two separate scratchpads, such as those shown in FIG. 2D, may provide the agent with certain advantages during the interaction with the customer. For example, the agent is able to use two distinct scratchpad windows 204A and 204B. The agent may decide to enter information of a first type, such as problem information, into the scratchpad window 204A. The agent may then decide to enter information of a second type, such as shipping information, into the scratchpad window 204B. The use of both of the scratchpad windows 204A and 204B allow the agent to organize information in a logical fashion. In one embodiment, the agent may use more than two scratchpad windows to record information, In this embodiment, the application window 200 contains an additional scratchpad button and an additional import button (not shown). When the agent uses both of the scratchpad windows 204A and 204B, the agent can selectively import the contents of these windows into the data-entry area 214 of the application window 200. For example, if the agent only wants to import the contents 206 of the scratchpad window 204A, the agent selects the import button 212A. If the agent only wants to import the contents 216 of the scratchpad window 204B, the agent selects the import button 212B. By selecting both of the import buttons 212A and 212B, the agent imports the contents 206 and 216 of each of the scratchpad windows 204A and 204B, respectively.

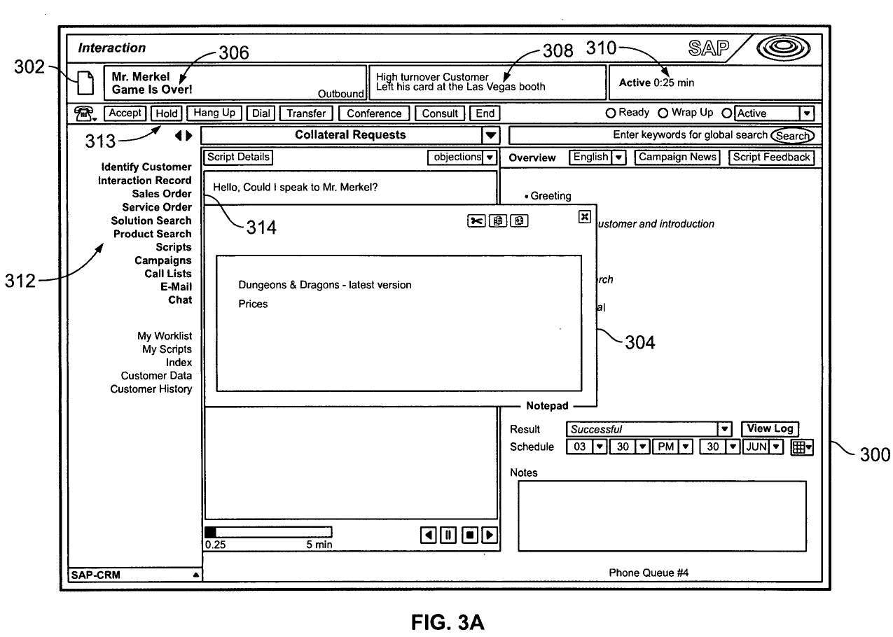

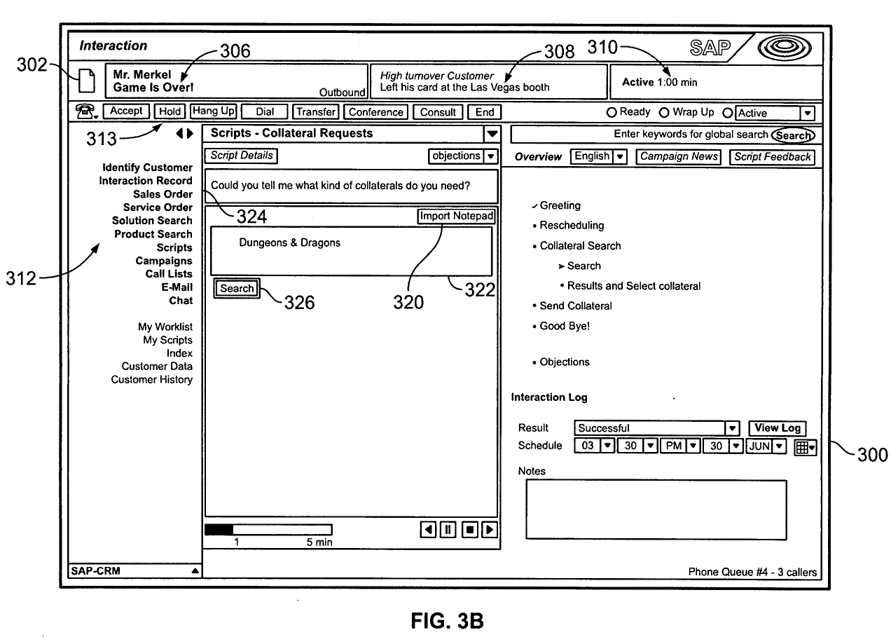

FIG. 3A and FIG. 3B are screen diagrams of application and scratchpad windows used in an interaction center application during various phases of an interaction, according to one embodiment. In FIG. 3A, an interaction center window 300 includes information that is associated with a first phase of the interaction. During this phase, a customer-service agent, such as a call-center agent, is able to enter text into a scratchpad window 304. This text may then be later imported into a text field and modified by the agent during a second phase of the interaction, as shown in FIG. 3B.

Referring to FIG. 3A, the window 300 contains various window areas 306, 308, 310, and 312 that contain information displayed to the agent during various different phases of the interaction. In the example shown, the agent interacts with the customer via a telephone connection and may use any of a series of buttons 313 to manage the telephone connection. The window area 306 displays information about the customer that is continually visible to the agent. As shown in FIG. 3A, the window area 306 contains the name of the customer (“Mr. Merkel”) and the name of the customer's organization (“Game Is Over!”). By looking at the window area 306, the agent will is able to quickly and easily refer to the customer's contact information.

The window area 308 contains additional information related to the customer that is displayed to the agent. In certain instances, the window area 308 does not contain any additional information. In other instances, however, such as the one shown in FIG. 3A, the window area 308 contains information that may be important to the agent when interacting vith the customer. For example, if the customer is a “high turnover” customer, the agent may decide to make a special offer to the customer to retain good business standing. The window area 310 contains information relating to the duration of the telephone interaction with the customer. In certain instances, the agent may need to monitor the window area 310 to ensure that a given transaction is completed in a specified period of time.

The window area 312 contains a set of links that may be used by the agent during the interaction with the customer. For example, if the customer has called the agent to purchase a product, the agent may select the “Sales Order” link within the window are 312. If the agent needs to conduct a search, the agent may then select the “Product Search” link. If the customer would prefer to communicate using an interactive chat session, the agent may select the “Chat” link. When the interaction with the customer is complete, the agent may select the “Interaction Record” link to specify and records details of the completed interaction.

In the example shown in FIG. 3A, the agent has selects the “Scripts” link within the window area 312. Upon selection of this link, an interactive script is displayed to the agent within a window area 314. The contents of the script are specific to the corresponding phase of the interaction and are read to the customer by the agent during the interaction. An introductory portion of the script is displayed to the agent in FIG. 3A (“Hello, Could I speak to Mr. Merkel?).

After asking this question to and further engaging in conversation with the customer during the first phase of the interaction with the customer, the agent may choose to open the scratchpad window 304 to record notes that the agent feels may be important to the interaction. The agent selects the scratchpad button 302 to open the scratchpad window 304. The scratchpad button 302 is persistently visible to the agent during the various phases of the interaction with the customer.

In the example shown in FIG. 3A, the scratchpad window 304 is a pop-up window. This window is activated and shown in front of the window 300. The agent may enter text into the scratchpad window 304. If the customer indicates that he or she may be interested in the latest version of a game, such as “Dungeons & Dragons”, the agent may enter such information into the scratchpad window 304. By doing so, the agent does not need to manually record information, and may also refer to or use such information at a later point in the transaction. Once the agent has finished entering information into the scratchpad window 304, the agent may close the window or continue working directly within the window 300.

Referring to FIG. 3B, the window 300 is also displayed to the agent during a second phase of the interaction with the customer. During this phase, the agent processes new information while interacting with the customer. As shown in a window area 324, the GUI displays to the agent a new portion of a script to be read to the customer. In the example, the agent may read the script to ask the customer about collateral products. If the agent previously entered information into the scratchpad window 304 that is applicable to the second phase of the interaction, the agent may select an import button 320 to import the contents of the scratchpad window 304 into a data-entry area 322.

For example, if the customer had previously indicated an interest in a “Dungeons & Dragons” product, and if the agent had previously recorded information relating to this 13906-144001 /2003P00175 USOI interest within the scratchpad window 304, the agent could later select the import button 320 to import this information into the data-entry area 322. The agent could then modify this information after it has been imported. Subsequently, the agent is able to select a search button 326 to search for collateral products that relate to “Dungeons & Dragons”. By using the scratchpad window 304 and the import button 320, the agent is able to digitally record information during any phase of the interaction with the customer and then later import this information into a data-entry area for use in a subsequent phase of the interaction.

FIG. 4 is a block diagram of a computing system 400 that may be included within the customer and/or agent computing devices 102, 106, and 108 shown in FIG. 1, according to one embodiment. The computing system 400 includes a processor 402, a memory 404, a storage device 406, and an input/output device 408. Each of the components 402, 404, 406, and 408 are interconnected using a system bus. The processor 402 is capable of processing instructions for execution within the computing system 400. In one embodiment, the processor 402 is a single-threaded processor. In another embodiment, the processor 402 is a multi-threaded processor. The processor 402 is capable of processing instructions stored in the memory 404 or on the storage device 406 to display graphical information for a GUI on the input/output device 408.

The memory 404 stores information within the computing system 400. In one embodiment, the memory 404 is a computer-readable medium. In one embodiment, the memory 404 is a volatile memory unit. In another embodiment, the memory 404 is a non-volatile memory unit.

The storage device 406 is capable of providing mass storage for the computing system 400. In one embodiment, the storage device 406 is a computer-readable medium. In various different embodiments, the storage device 406 may be a floppy disk device, a hard disk device, an optical disk device, or a tape device.

In one implementation, a computer program product is tangibly embodied in an information carrier. The computer program product contains instructions that, when executed, perform various methods, such as those described above. The information carrier is a computer- or machine-readable medium, such as the memory 404, the storage device 406, or a propagated signal.

The input/output device 408 provides input/output operations for the computing system 400. In one embodiment, the input/output device 408 includes a keyboard and/or pointing device. In one embodiment, the input/output device 408 includes a display unit for displaying the various GUI's shown in the preceding figures.

A number of embodiments of the invention have been described. Nevertheless, it will be understood that various modifications may be made without departing from the spirit and scope of the invention. Accordingly, other embodiments are within the scope of the following claims.

1. A method for providing a scratchpad window in a graphical user interface (GUI) while using an application that manages an interaction between an agent and an individual, the method comprising:
upon entry of a first selection made by the agent in an application window used by the application and displayed in the GUI to the agent during the interaction with the individual, displaying the scratchpad window in the GUI;
accepting input from the agent that is entered as information into the scratchpad window; and
upon entry of a second selection made by the agent in the application window within the GUI, importing the information contained within the scratchpad window into a data-entry area of the application window.

2. The method of claim 1, wherein importing the information contained within the scratchpad window into a data-entry area of the application window includes importing all of the information contained within the scratchpad window into the data-entry area of the application window.

3. The method of claim 1, further comprising:
upon entry of a third selection made by the agent in the application window within the GUI, displaying a second scratchpad window in the GUI; and
accepting input from the agent that is entered as information into the second scratchpad window.

4. The method of claim 3, further comprising importing the information contained within the second scratchpad window into the data-entry area of the application window upon entry of a fourth selection made by the agent in the application window within the GUI.

5. The method of claim 1, further comprising accepting input from the agent to modify the information contained within the data-entry area of the application window after it has been imported from the scratchpad window.

6. The method of claim 1, further comprising displaying in the scratchpad window the information previously entered within the scratchpad window upon entry of a third selection made by the agent.

7. The method of claim 1, further comprising deleting all information contained within the scratchpad window upon receiving notification that the interaction between the agent and the individual has ended.

8. The method of claim 1, further comprising designating the scratchpad window as a background window within the GUI when the agent activates the application window.

9. The method of claim 1, wherein the scratchpad window is a pop-up window.

10. The method of claim 1, wherein the first selection made by the agent is a selection of a button in the application window.

11. The method of claim 1, wherein the second selection made by the agent is a selection of a button in the application window.

12. The method of claim 1, wherein the interaction between the agent and the individual is selected from a group consisting of a chat interaction, an email interaction, a phone interaction, and a fax interaction.

13. The method of claim 1, wherein the data-entry area of the application window is a text-entry field.

14. A method for providing a scratchpad window in a graphical user interface (GUI) while using an application that manages an interaction between an agent and an individual, the method comprising:
during a first phase of the interaction between the agent and the individual in the application, accepting input from the agent that is entered into a graphical scratchpad using the GUI, the graphical scratchpad being displayed within a pop-up window within the GUI; and
during a second phase of the interaction between the agent and the individual in the application, displaying in the graphical scratchpad the previously accepted input and accepting additional input from the agent that is further entered into the graphical scratchpad using the GUI, wherein the second phase of the interaction is distinct from the first phase.

15. The method of claim 14, further comprising importing information contained within the graphical scratchpad into a data-entry area of an application window used by the application and displayed in the GUI to the agent during the interaction with the individual.

16. The method of claim 15, further comprising modifying the information contained within the data-entry area of the application window after it has been imported from the graphical scratchpad upon receipt of input from the agent.

17. The method of claim 15, wherein the data-entry area of the application window is a text-entry field.

18. The method of claim 15, wherein importing information contained within the graphical scratchpad into a data-entry area of the application window includes importing all information contained within the graphical scratchpad into the data-entry area of the application window.

19. The method of claim 14, further comprising storing information contained in the graphical scratchpad in a back-end system.

20. The method of claim 14, further comprising storing information contained in the graphical scratchpad in a storage area used by the application.

21. The method of claim 14, further comprising deleting all information contained within the scratchpad window upon receiving notification that the interaction between the agent and the individual has ended.

22. The method of claim 14, wherein the interaction between the agent and the individual is selected from a group consisting of a chat interaction, an email interaction, a phone interaction, and a fax interaction.

23. A system for providing a scratchpad window in a graphical user interface (GUI) while using an application that manages an interaction between an agent and an individual, the system being programmed to:
upon entry of a first selection made by the agent in an application window used by the application and displayed in the GUI to the agent during the interaction with the individual, display the scratchpad window in the GUI;
accept input from the agent that is entered as information into the scratchpad window; and
upon entry of a second selection made by the agent in the application window within the GUI, import the information contained within the scratchpad window into a data-entry area of the application window.

24. A system for providing a scratchpad window in a graphical user interface (GUI) while using an application that manages an interaction between an agent and an individual, the system being programmed to:
during a first phase of the interaction between the agent and the individual in the application, accept input from the agent that is entered into a graphical scratchpad using the GUI, the graphical scratchpad being displayed within a pop-up window within the GUI; and
during a second phase of the interaction between the agent and the individual in the application, display in the graphical scratchpad the previously accepted input and accepting additional input from the agent that is further entered into the graphical scratchpad using the GUI, wherein the second phase of the interaction is distinct from the first phase.

25. A computer program product tangibly embodied in an information carrier, the computer program product including instructions that, when executed, perform a method for providing a scratchpad window in a graphical user interface (GUI) while using an application that manages an interaction between an agent and an individual, the method comprising:
upon entry of a first selection made by the agent in an application window used by the application and displayed in the GUI to the agent during the interaction with the individual, displaying the scratchpad window in the GUI;
accepting input from the agent that is entered as information into the scratchpad window; and
upon entry of a second selection made by the agent in the application window within the GUI, importing the information contained within the scratchpad window into a data-entry area of the application window.

26. A computer program product tangibly embodied in an information carrier, the computer program product including instructions that, when executed, perform a method for providing a scratchpad window in a graphical user interface (GUI) while using an application that manages an interaction between an agent and an individual, the method comprising:
during a first phase of the interaction between the agent and the individual in the application, accepting input from the agent that is entered into a graphical scratchpad using the GUI, the graphical scratchpad being displayed within a pop-up window within the GUI; and
during a second phase of the interaction between the agent and the individual in the application, displaying in the graphical scratchpad the previously accepted input and accepting additional input from the agent that is further entered into the graphical scratchpad using the GUI, wherein the second phase of the interaction is distinct from the first phase.
